(19) United States
(12) Patent Application Publication
(10) Pub. No.: US 2016/0143072 A1
(43) Pub. Date: May 19, 2016

(54) SUPPORT FOR PEER-TO-PEER DISCOVERY IN 5 GHZ BAND

(71) Applicant: QUALCOMM Incorporated, San Diego, CA (US)

(72) Inventors: Ganesh Kondabattini, Hyderabad (IN); Manishekar Chandrasekaran, Hyderabad (IN); Nirav Nayan Shah, Hyderabad (IN)

(21) Appl. No.: 14/542,300

(22) Filed: Nov. 14, 2014

(51) Int. Cl. H04W 76/02; H04W 72/04; H04L 29/08; H04W 8/00

(52) U.S. Cl. CPC H04W 76/023; H04W 76/021; H04W 8/005; H04W 72/0453; H04L 67/1061

(57) ABSTRACT

A method and apparatus are disclosed that allow a first wireless device to form a peer-to-peer (P2P) connection with a second wireless device that does not operate on the social channels of a first frequency band. The first wireless device receives, from the second wireless device, an action frame indicating a selected channel in a second frequency band. The first wireless device may scan a number of social channels in the first frequency band to discover a presence of another wireless device, and then scans the selected channel to discover the presence of the second wireless device.

### TECHNICAL FIELD

The disclosure relates generally to wireless networks, and specifically to forming a peer-to-peer wireless network.

### BACKGROUND OF RELATED ART

A Wi-Fi network may be formed by one or more access points (APs) that provide a wireless communication channel or link with a number of wireless devices or stations (STAs). Each AP, which may correspond to a Basic Service Set (BSS), periodically broadcasts beacon frames to enable any STAs within wireless range of the AP to establish and/or maintain a communication link with the Wi-Fi network. The beacon frames, which may include a traffic indication map (TIM) and timing synchronization function (TSF) values, are typically broadcast according to a target beacon transmission time (TBTT) schedule.

An Independent Basic Service Set (IBSS) network, such as an ad-hoc network or peer-to-peer (P2P) network, may be formed by a number of STAs without the presence of an AP. For P2P networks operating according to the Wi-Fi Alliance P2P Specification, which is also known as “Wi-Fi Direct,” one of the STAs may be designated as the Group Owner, and the other STAs may be designated as P2P clients. The P2P Group Owner may perform many functions of an AP such as, for example, broadcasting beacon frames to other STAs in the P2P group. The broadcasted beacon frame includes the Group Owner's TSF value, as well as required operational parameters, supported capabilities, membership, and services available within the P2P Group.

To form a P2P network, a wireless device may search for and identify other suitable wireless devices during a device discovery operation. According to current Wi-Fi Direct protocols, the wireless device may scan the 3 social channels (e.g., channels 1, 6, and 11 in the 2.4 GHz band) for incoming beacon frame transmissions and/or may broadcast probe requests on the 3 social channels to locate and identify other devices with which to form the P2P network. After forming the P2P network, the member devices may select the Group Owner, for example, using a group owner negotiation process.

Because current Wi-Fi Direct protocols call for wireless devices to perform P2P device discovery operations using the 3 social channels in the 2.4 GHz frequency band, a wireless device that supports only 5 GHz communications may not be able to discover (or be discovered by) other P2P devices, and therefore may not be able to form and/or join a P2P network.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A device and method of discovering and/or establishing a wireless connection with a wireless device are disclosed. In accordance with some embodiments, a first wireless device may form a peer-to-peer (P2P) connection with a second wireless device, where the first wireless device operates in a first frequency band and a second frequency band different than the first frequency band, and the second wireless device operates in the second frequency band. For some example embodiments, the first frequency band is centered at approximately 2.4 GHz and includes social channels 1, 6, and 11, and the second frequency band is centered at approximately 5 GHz.

The first wireless device may receive, from the second wireless device, an action frame indicating a selected channel in the second frequency band. The first wireless device may scan a number of social channels in the first frequency band to discover a presence of another wireless device, and may scan the selected wireless channel in the second frequency band to discover the presence of the second wireless device. Thereafter, the first wireless device may establish the connection on the selected channel of the second frequency band. For some embodiments, the action frame includes a vendor specific information element (VSIE) indicating the selected channel.

For some embodiments, the first wireless device may scan the number of social channels by sending a probe request on a corresponding one of the number of social channels during each of a number of first search states, and may determine whether a probe response is received from other wireless devices on each of the social channels during each of a number of first listen states; the first wireless device may scan the selected channel by sending a probe request on the selected channel during a second search state, and may determine whether a probe response is received from the second wireless device on the selected channel during a second listen state.

For some embodiments, a respective one of the first search states and the second search state are performed in a single corresponding search operation, and a respective one of the first listen states and the second listen state are performed in a single corresponding listen operation. For at other embodiments, the number of first search states and the number of first listen states may be performed during a first find operation, and the second search state and the second listen state may be performed during a second find operation.

### BRIEF DESCRIPTION OF THE DRAWINGS

The present embodiments are illustrated by way of example and are not intended to be limited by the figures of the accompanying drawings. Like numbers reference like elements throughout the drawings and specification.

FIG. 1 depicts an example system within which the present embodiments may be implemented.

FIG. 2 shows a wireless device that is one embodiment of at least one of the stations of FIG. 1.

FIG. 3A is an example sequence diagram depicting a device discovery operation in accordance with some embodiments.

FIG. 3B depicts search and listen states for the first wireless device in the example sequence diagram of FIG. 3A.

FIG. 4A is an example sequence diagram depicting a device discovery operation in accordance with other embodiments.

FIG. 4B depicts search and listen states for the first wireless device in the example sequence diagram of FIG. 4A.

FIGS. 5A-5B show illustrative flow charts depicting an example device discovery operation in accordance with some embodiments.

### DETAILED DESCRIPTION

Embodiments are described below in the context of Wi-Fi enabled devices for simplicity only. It is to be understood that the disclosure is equally applicable for devices using signals of other various wireless standards or protocols. As used herein, the terms “wireless local area network (WLAN)” and “Wi-Fi” can include communications governed by the IEEE 802.11 standards, BLUETOOTH® (Bluetooth or BT), HiperLAN (a set of wireless standards, comparable to the IEEE 802.11 standards, used primarily in Europe), and other technologies used in wireless communications.

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

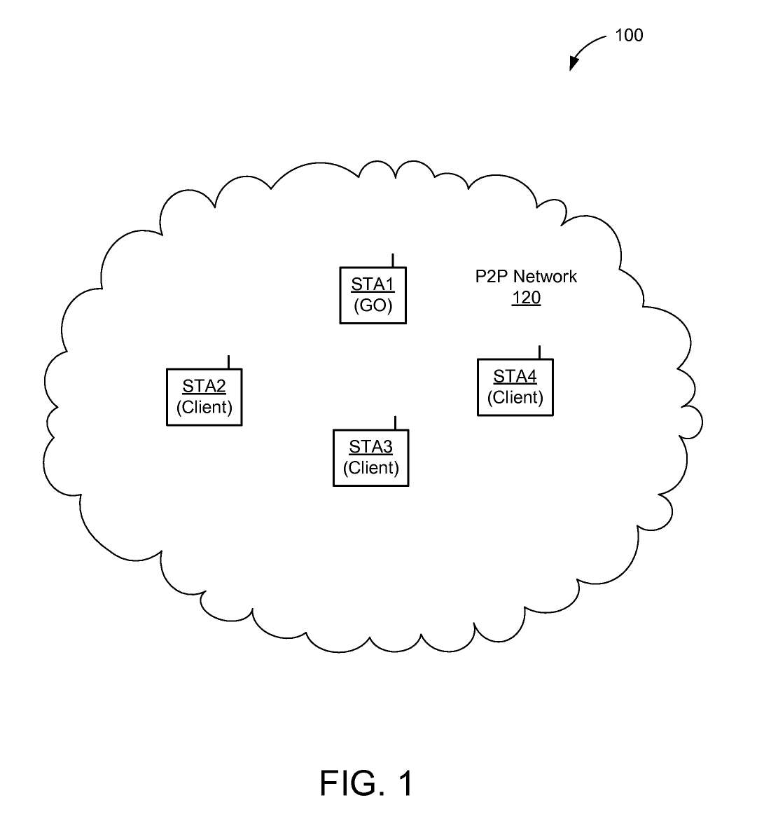

FIG. 1 is a block diagram of a wireless network system 100 within which the present embodiments may be implemented. The system 100 is shown to include four wireless devices or stations STA1-STA4 associated with a peer-to-peer (P2P) network 120. The P2P network 120, which may also be referred to as an ad-hoc network, an independent basic service set (IBSS) network, or a Wi-Fi Direct network, may operate according to the IEEE 802.11 family of standards (or according to other suitable wireless protocols). For at least some embodiments, the P2P network 120 may operate according to the Wi-Fi Alliance P2P Specification.

For the example P2P network 120 of FIG. 1, station STA1 is designated as the Group Owner (GO), and stations STA2-STA4 are designated as P2P clients. As the GO, station STA1 may serve as a gateway for the P2P clients (e.g., to another network), and may perform many of the functions of an access point (AP) in an infrastructure mode WLAN (e.g., setting up and tearing down the P2P network 120, admitting new members to the P2P network 120, broadcasting beacon frames, and so on).

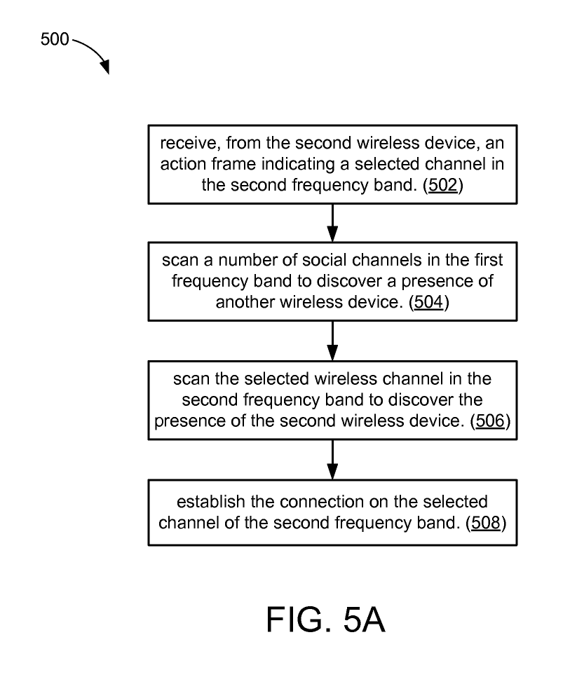

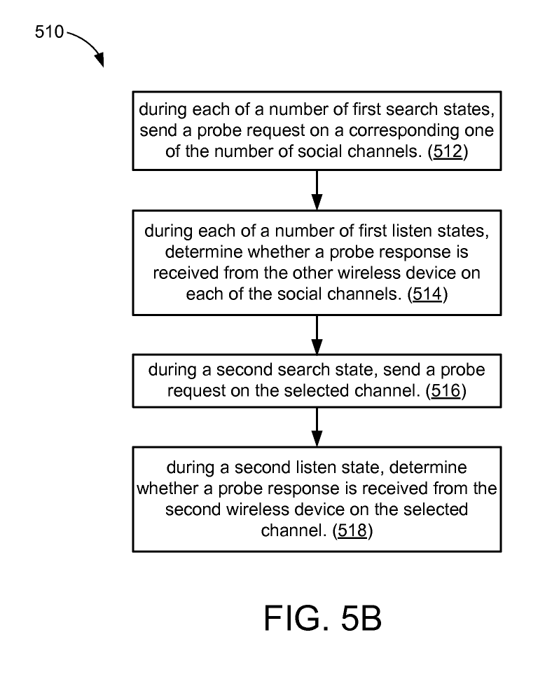

The stations STA1-STA4 may be any suitable Wi-Fi enabled wireless devices including, for example, cell phones, personal digital assistants (PDAs), tablet devices, laptop computers, or the like. For at least some embodiments, stations STA1-STA4 may include a transceiver, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 5A-5B.

To establish a wireless connection between two P2P devices, the devices may perform device discovery operations and/or service discovery operations. During device discovery operations, a client STA (e.g., a STA requesting a particular P2P service) determines the identity and/or availability of other STAs within Wi-Fi communication range, for example, by scanning the 3 social channels (e.g., channels 1, 6, and 11 in the 2.4 GHz band) for incoming beacon frames and/or by broadcasting probe request frames to any STAs that may be listening on those channels. Thereafter, during the service discovery phase, the client STA may query the available peer STAs (discovered during the device discovery phase) about the services they provide. The client STA may transmit service discovery requests to each peer STA that supports the service discovery operation, one at a time, until the client STA identifies a peer STA that provides the requested service.

As mentioned above, current Wi-Fi Direct protocols call for wireless devices to perform P2P device discovery operations using the 3 social channels in the 2.4 GHz frequency band (i.e., channels 1, 6, and 11), and therefore a wireless device that supports wireless communications in only the 5 GHz frequency band may not be able to discover (or be discovered by) other P2P devices, and therefore may not be able to form and/or join a P2P network. Thus, in accordance with the present embodiments, a first wireless device that operates in both the 2.4 GHz and 5 GHz frequency bands may discover (or be discovered by) a second wireless device that operates only in the 5 GHz frequency band by allowing the second wireless device to inform the first wireless device of a selected channel in the 5 GHz frequency band that the second wireless device may be listening on. In response thereto, the first wireless device may perform scanning operations on the selected channel in the 5 GHz frequency band (e.g., in addition to scanning the social channels in the 2.4 GHz frequency band). More specifically, the first wireless device may, while in a search state, send probe requests to the second wireless device on the selected channel while the second wireless device is in a listen state. The second wireless device may receive the probe request, and respond by sending a probe response back to the first wireless device. These and other features of the present embodiments are described in more detail below.

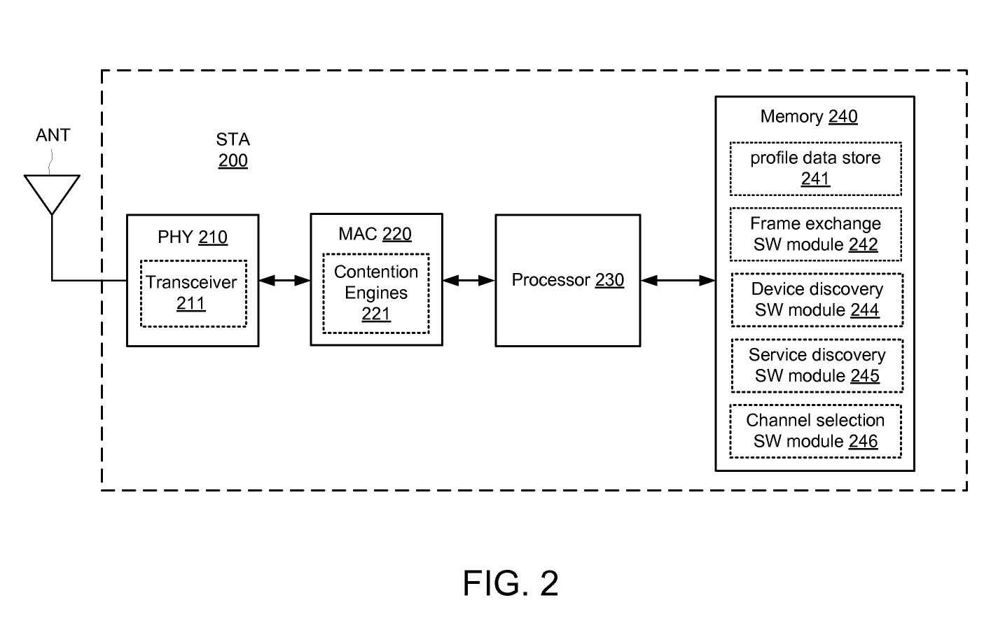

FIG. 2 shows a STA 200 that is one embodiment of at least one of the stations STA1-STA4 of FIG. 1. The STA 200 may include a PHY device 210, a MAC device 220, a processor 230, and a memory 240. The PHY device 210 may include at least a Wi-Fi transceiver 211. The MAC device 220 may include at least a number of contention engines 221. The Wi-Fi transceiver 211 may be used to transmit signals to and receive signals from other wireless devices (e.g., stations shown in FIG. 1 and/or a number of other wireless devices such as access points) via an antenna ANT, and may be used to scan the surrounding environment to detect and identify nearby wireless devices. Although only one antenna is shown in FIG. 2 for simplicity, for actual embodiments, STA 200 may include any number of antennas, for example, to provide multiple-input multiple-output (MIMO) functionality.

For purposes of discussion herein, MAC device 220 is shown in FIG. 2 as being coupled between PHY device 210 and processor 230. For actual embodiments, PHY device 210, MAC device 220, processor 230, and/or memory 240 may be connected together using one or more buses (not shown for simplicity).

The contention engines 221 may contend for access to the shared wireless medium of P2P network 120 and may also store packets for transmission over the shared wireless medium. The STA 200 may include one or more contention engines 221 for each of a plurality of different access categories. For other embodiments, the contention engines 221 may be separate from MAC device 220. For still other embodiments, the contention engines 221 may be implemented as one or more software modules (e.g., stored in memory 240 or stored in memory provided within MAC device 220) containing instructions that, when executed by processor 230, perform the functions of contention engines 221.

Memory 240 may include a profile data store 241 that stores profile information for a plurality of devices such as APs and/or other STAs. The profile information for a particular device may include information including, for example, the device's SSID, channel information, frequency bands of operation, RSSI values, supported data rates, P2P capabilities and services, and any other suitable information pertaining to or describing the operation of the device.

Further, although not shown for simplicity, memory 240 may include a medium access parameters table and a number of packet queues. The medium access parameters table may store a number of medium access parameters including, for example, transmission schedules, contention windows, contention window sizes, back-off periods, random back-off numbers, and/or other information associated with contending for and/or controlling access to the wireless medium of the P2P network 120 of FIG. 1. The packet queues may store packets to be transmitted from STA 200 to other STAs (or an associated AP). For some embodiments, the memory 240 may include one or more packet queues for each of a plurality of different priority levels or access categories.

Memory 240 may also include a non-transitory computer-readable medium (e.g., one or more nonvolatile memory elements, such as EPROM, EEPROM, Flash memory, a hard drive, and so on) that can store the following software modules:
a frame exchange software module 242 to facilitate the exchange of frames (e.g., probe requests, probe responses, control frames, action frames, management frames, data frames, ACK frames, beacon frames, association frames, and so on), for example, as described for operations of FIGS. 5A-5B;
a device discovery software module 244 to perform P2P device discovery operations to find, identify, and establish a wireless connection with another wireless device in a first frequency band and/or a second frequency band, for example, as described for operations of FIGS. 5A-5B;
a service discovery software module 245 to perform P2P service discovery operations to identify services offered by one or more peer device (e.g., identified during a device discovery operation);
a channel selection software module 246 to select one or more channels in the second frequency band and to inform other wireless devices to scan the selected channel(s) during device discovery operations, for example, as described for operations of FIGS. 5A-5B.
   Each software module includes instructions that, when executed by processor 230, cause STA 200 to perform the corresponding functions. The non-transitory computer-readable medium of memory 240 thus includes instructions for performing all or a portion of the operations depicted in FIGS. 5A-5B.

Processor 230, which is shown in the example of FIG. 2 as coupled to PHY device 210 and transceiver 211, to MAC device 220 and contention engines 221, and to memory 240, may be one or more suitable processors capable of executing scripts or instructions of one or more software programs stored in STA 200 (e.g., within memory 240). For example, processor 230 may execute frame exchange software module 242 to facilitate the exchange of frames (e.g., probe requests, probe responses, control frames, action frames, management frames, data frames, ACK frames, beacon frames, association frames, and so on). Processor 230 may also execute device discovery software module 244 to perform P2P device discovery operations to find, identify, and establish a wireless connection with another wireless device in a first frequency band and/or a second frequency band. Processor 230 may also execute service discovery software module 245 to perform P2P service discovery operations to identify services offered by one or more peer device (e.g., identified during a device discovery operation). Processor 230 may also execute channel selection software module 246 to select one or more channels in the second frequency band and to inform other wireless devices to scan the selected channel(s) during device discovery operations.

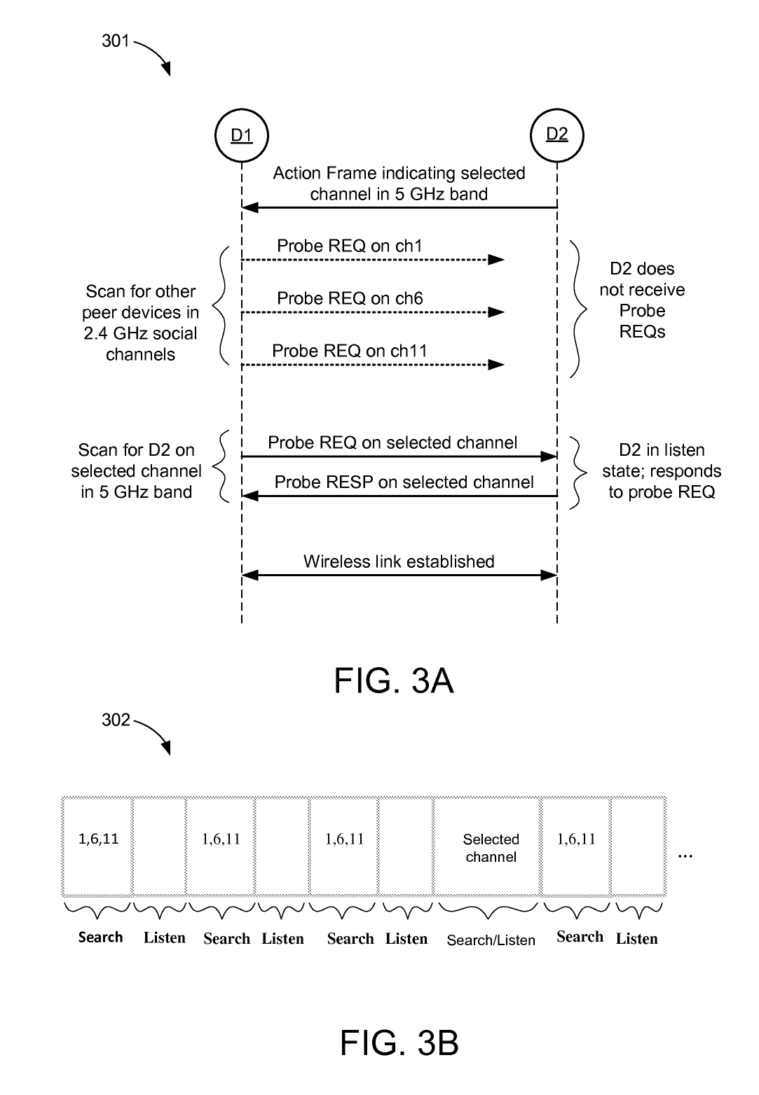

FIG. 3A shows a sequence diagram 301 depicting a first wireless device (D1) forming a wireless connection with a second wireless device (D2) in accordance with some embodiments. For the example of FIG. 3A, D1 operates in a first frequency band centered at approximately 2.4 GHz and in a second frequency band centered at approximately 5 GHz, and D2 operates only in the second frequency band. For other embodiments, the first frequency band and/or the second frequency band may be centered at other frequencies (e.g., the second frequency band may be centered at 60 GHz for WiGig operations).

First, D2 sends an action frame to D1. The action frame may indicate a selected channel in the second frequency band on which D2 may listen for probe requests. For some embodiments, the selected channel may be provided within a vendor specific information element (VSIE) in the action frame. For other embodiments, D2 may indicate the selected channel using other fields of the action frame, and/or may indicate the selected channel using frames other than action frames. D1 receives the action frame from D2, and may store the selected channel (e.g., in profile data store 241).

D1 begins scanning operations on the 3 social channels of the 2.4 GHz frequency band. More specifically, D1 may send a probe REQ on channel 1 of the 2.4 GHz frequency band, then send a probe REQ on channel 6 of the 2.4 GHz frequency band, and lastly send a probe REQ on channel 11 of the 2.4 GHz frequency band. Because D2 does not operate in the 2.4 GHz frequency band, the probe REQs on the social channels are not heard by D2.

After not receiving a response from D2, D1 may send a probe REQ on the selected channel of the 5 GHz frequency band. Because D2 is in a listen state on the selected channel, D2 receives the probe REQ and responds by sending a probe RESP back to D1. D1 receives the probe RESP, and thereafter forms a P2P connection with D2.

For some embodiments, D1 may scan for peer devices (e.g., such as D2) on the social channels of the 2.4 GHz frequency band any number of times before scanning on the selected channel of the 5 GHz frequency band. For example, referring also to the example diagram 302 of FIG. 3B, D1 may alternately toggle between search and listen states on the social channels an example number N=3 times before searching and listening on the selected channel of the 5 GHz frequency band. In this manner, D1 may discover other peer devices operating on the social channels prior to discovering D2 on the selected channel of the 5 GHz frequency band. After scanning on the selected channel of the 5 GHz frequency band, D1 may return to scanning the social channels for another number of times. For at least one embodiment, D1 may remain in the listen state on the selected channel of the 5 GHz frequency band for periods of time that are longer than the listen times for the social channels on the 2.4 GHz frequency band.

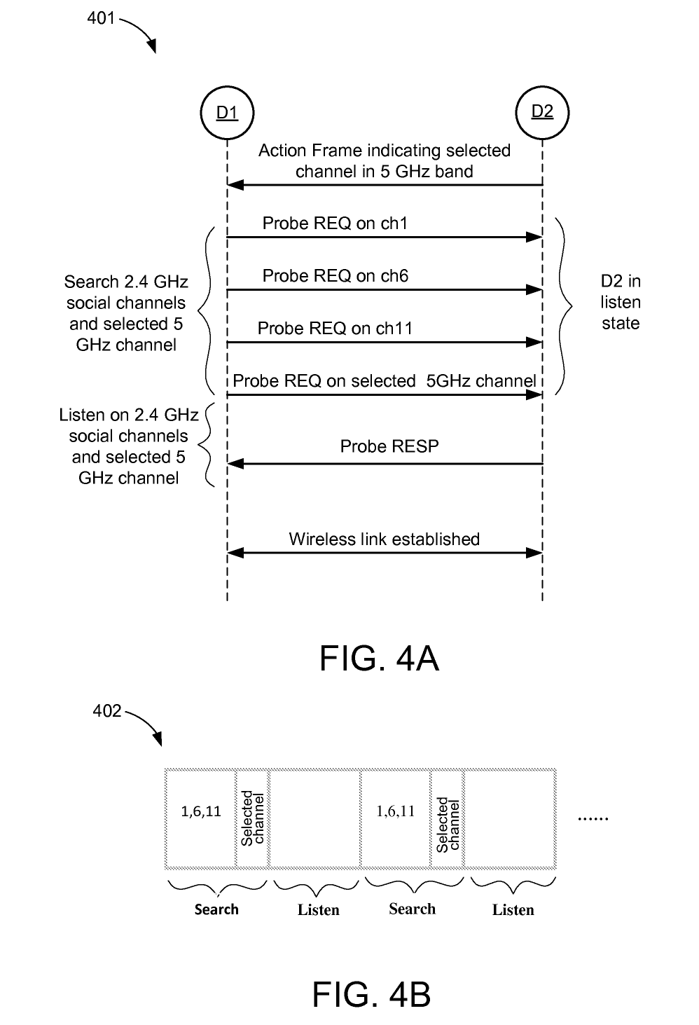

FIG. 4A shows a sequence diagram 401 depicting a first wireless device (D1) forming a wireless connection with a second wireless device (D2) in accordance with other embodiments. For the example of FIG. 4A, D1 operates in the first frequency band centered at approximately 2.4 GHz and in the second frequency band centered at approximately 5 GHz, and D2 also operates in both the first and second frequency bands. For other embodiments, the first frequency band and/or the second frequency band may be centered at other frequencies (e.g., the second frequency band may be centered at 60 GHz for WiGig operations).

First, D2 sends an action frame to D1. The action frame may indicate a selected channel in the second frequency band on which D2 may listen for probe requests. For some embodiments, the selected channel may be provided within a vendor specific information element (VSIE) in the action frame. For other embodiments, D2 may indicate the selected channel using other fields of the action frame, and/or may indicate the selected channel using frames other than action frames. D1 receives the action frame from D2, and may store the selected channel (e.g., in profile data store 241).

D1 begins scanning operations on the 3 social channels of the 2.4 GHz frequency band and the selected channel of the 5 GHz frequency band. More specifically, D1 may send a probe REQ on channel 1 of the 2.4 GHz frequency band, send a probe REQ on channel 6 of the 2.4 GHz frequency band, send a probe REQ on channel 11 of the 2.4 GHz frequency band, and lastly send a probe REQ on the selected channel of the 5 GHz frequency band. D2 is in the listen state during this time, and receives at least one of the probe REQs from D1. D2 responds by sending a probe RESP back to D1. D1 receives the probe RESP, and thereafter forms a P2P connection with D2.

For some embodiments, D1 may scan for peer devices (e.g., such as D2) on each of the social channels of the 2.4 GHz frequency band and then on the selected channel of the 5 GHz frequency band (e.g., during a single search operation). For example, referring also to the example diagram 402 of FIG. 4B, D1 may search the 2.4 GHz social channels and the selected 5 GHz channel during a single search operation, and then listen on the 2.4 GHz social channels and the selected 5 GHz channel during a single listen operation. This process may be repeated any number of times, as depicted in FIG. 4B.

FIG. 5A shows an illustrative flow chart 500 depicting an example operation for a first wireless device to form a peer-to-peer (P2P) connection with a second wireless device in accordance with some embodiments. For the example of FIG. 5A, the first wireless device operates in a first frequency band (e.g., 2.4 GHz) and a second frequency band (e.g., 5 GHz) different than the first frequency band, and the second wireless device operates in the second frequency band. The first wireless device receives, from the second wireless device, an action frame indicating a selected channel in the second frequency band (502). The first wireless device scans a number of social channels in the first frequency band to discover a presence of another wireless device (504). The first wireless device then scans the selected wireless channel in the second frequency band to discover the presence of the second wireless device (506). Next, the first wireless device establishes a wireless connection with the second wireless device on the selected channel of the second frequency band (508).

The first wireless device may scan the social channels in the first frequency band and the selected channel in the second frequency band in various orders. For one example, the first wireless device may search and listen on all of the social channels during first search and listen states, and then search and listen on the selected channel during a second search and listen state. Referring to the example flow chart 510 of FIG. 5B, the first wireless device may first scan a number of social channels by sending a probe request on a corresponding one of the number of social channels during each of a number of first search states (512). Then, the first wireless device may determine whether a probe response is received from the other wireless device on each of the social channels during each of a number of first listen states (514). The first wireless device may then scan the selected wireless channel by sending a probe request on the selected channel during a second search state (516), and then determine whether a probe response is received from the second wireless device on the selected channel during a second listen state (518).

In the foregoing specification, embodiments of the disclosure have been described with reference to specific examples. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for a first wireless device to form a peer-to-peer (P2P) connection with a second wireless device, the first wireless device operating in a first frequency band and a second frequency band different than the first frequency band, the second wireless device operating in the second frequency band, the method performed by the first wireless device and comprising:
receiving, from the second wireless device, an action frame indicating a selected channel in the second frequency band;
scanning a number of social channels in the first frequency band to discover a presence of another wireless device;
scanning the selected channel in the second frequency band to discover the presence of the second wireless device; and
establishing the connection on the selected channel of the second frequency band.

2. The method of claim 1, wherein the action frame includes a vendor specific information element (VSIE) indicating the selected channel.

3. The method of claim 1, wherein the first frequency band is centered at approximately 2.4 GHz and the social channels include channels 1, 6, and 11 of the first frequency band, and wherein the second frequency band is centered near at least one from the group consisting of approximately 900 MHz, 5 GHz, and 60 GHz.

4. The method of claim 1, wherein the first wireless device operates concurrently in the first frequency band and the second frequency band.

5. The method of claim 1, wherein:
scanning the number of social channels comprises:
during each of a number of first search states, sending a probe request on a corresponding one of the number of social channels; and
during each of a number of first listen states, determining if a probe response is received from the other wireless device on any of the social channels; and
scanning the selected wireless channel comprises:
during a second search state, sending a probe request on the selected channel; and
during a second listen state, determining if a probe response is received from the second wireless device on the selected channel.

6. The method of claim 5, wherein a respective one of the first search states and the second search state are performed in a single corresponding search operation, and a respective one of the first listen states and the second listen state are performed in a single corresponding listen operation.

7. The method of claim 5, wherein the number of first search states and the number of first listen states are performed during a first find operation, and the second search state and the second listen state are performed during a second find operation.

8. A first wireless device to form a peer-to-peer (P2P) connection with a second wireless device, the first wireless device operating in a first frequency band and a second frequency band different than the first frequency band, the second wireless device operating in the second frequency band, the first wireless device comprising:
a number of wireless transceivers;
one or more processors; and
a memory storing instructions that, when executed by the processor, cause the first wireless device to:
receive, from the second wireless device, an action frame indicating a selected channel in the second frequency band;
scan a number of social channels in the first frequency band to discover a presence of another wireless device;
scan the selected channel in the second frequency band to discover the presence of the second wireless device; and
establish the connection on the selected channel of the second frequency band.

9. The first wireless device of claim 8, wherein the action frame includes a vendor specific information element (VSIE) indicating the selected channel.

10. The first wireless device of claim 8, wherein the first frequency band is centered at approximately 2.4 GHz and the social channels include channels 1, 6, and 11 of the first frequency band, and wherein the second frequency band is centered near at least one from the group consisting of approximately 900 MHz, 5 GHz, and 60 GHz.

11. The first wireless device of claim 8, wherein the first wireless device operates concurrently in the first frequency band and the second frequency band.

12. The first wireless device of claim 8, wherein:
execution of the instructions to scan the number of social channels causes the first wireless device to:
during each of a number of first search states, send a probe request on a corresponding one of the number of social channels; and
during each of a number of first listen states, determine if a probe response is received from the other wireless device on any of the social channels; and
execution of the instructions to scan the selected wireless channel causes the first wireless device to:
during a second search state, send a probe request on the selected channel; and
during a second listen state, determine if a probe response is received from the second wireless device on the selected channel.

13. The first wireless device of claim 12, wherein a respective one of the first search states and the second search state are performed in a single corresponding search operation, and a respective one of the first listen states and the second listen state are performed in a single corresponding listen operation.

14. The first wireless device of claim 12, wherein the number of first search states and the number of first listen states are performed during a first find operation, and the second search state and the second listen state are performed during a second find operation.

15. A non-transitory computer-readable medium storing instructions to form a peer-to-peer (P2P) connection between a first wireless device and a second wireless device, the first wireless device operating in a first frequency band and a second frequency band different than the first frequency band, the second wireless device operating in the second frequency band, wherein execution of the instructions by a processor of a first wireless device causes the first wireless device to:
receive, from the second wireless device, an action frame indicating a selected channel in the second frequency band;
scan a number of social channels in the first frequency band to discover a presence of another wireless device;
scan the selected channel in the second frequency band to discover the presence of the second wireless device; and
establish the connection on the selected channel of the second frequency band.

16. The non-transitory computer-readable medium of claim 15, wherein the action frame includes a vendor specific information element (VSIE) indicating the selected channel.

17. The non-transitory computer-readable medium of claim 15, wherein the first frequency band is centered at approximately 2.4 GHz and the social channels include channels 1, 6, and 11 of the first frequency band, and wherein the second frequency band is centered near at least one from the group consisting of approximately 900 MHz, 5 GHz, and 60 GHz.

18. The non-transitory computer-readable medium of claim 15, wherein:
execution of the instructions to scan the number of social channels causes the first wireless device to:
during each of a number of first search states, send a probe request on a corresponding one of the number of social channels; and
during each of a number of first listen states, determine if a probe response is received from the other wireless device on any of the social channels; and
execution of the instructions to scan the selected wireless channel causes the first wireless device to:
during a second search state, send a probe request on the selected channel; and
during a second listen state, determine if a probe response is received from the second wireless device on the selected channel.

19. The non-transitory computer-readable medium of claim 18, wherein a respective one of the first search states and the second search state are performed in a single corresponding search operation, and a respective one of the first listen states and the second listen state are performed in a single corresponding listen operation.

20. The non-transitory computer-readable medium of claim 18, wherein the number of first search states and the number of first listen states are performed during a first find operation, and the second search state and the second listen state are performed during a second find operation.
